(19) United States
(12) Patent Application Publication
(10) Pub. No.: US 2014/0207799 A1
(43) Pub. Date: Jul. 24, 2014

(54) HILL-CLIMBING FEATURE SELECTION WITH MAX-RELEVANCY AND MINIMUM REDUNDANCY CRITERIA

(71) Applicant: INTERNATIONAL BUSINESS MACHINES CORPORATION, Armonk, NY (US)

(72) Inventors: David HAWS, New York, NY (US); Dan HE, Ossining, NY (US); Laxmi P. PARIDA, Mohegan Lake, NY (US)

(73) Assignee: INTERNATIONAL BUSINESS MACHINES CORPORATION, Armonk, NY (US)

(21) Appl. No.: 13/745,909

(22) Filed: Jan. 21, 2013

(51) Int. Cl. G06F 17/30

(52) U.S. Cl. 707/749

(57) ABSTRACT

Various embodiments select features from a feature space. In one embodiment a candidate feature set of k′ features is selected from at least one set of features based on maximum relevancy and minimum redundancy (MRMR) criteria. A target feature set of k features is identified from the candidate feature set, where k′>k. Each a plurality of features in the target feature set is iteratively updated with each of a plurality of k′−k features from the candidate feature set. The feature from the plurality of k′−k features is maintained in the target feature set, for at least one iterative update, based on a current MRMR score of the target feature set satisfying a threshold. The target feature set is stored as a top-k feature set of the at least one set of features after a given number of iterative updates.

### BACKGROUND

The present invention generally relates to the field of feature selection, and more particularly relates to a hill-climbing-based feature selection with Max-Relevancy and Min-Redundancy criteria.

Feature selection methods are critical for classification and regression problems. For example, it is common in large-scale learning applications, especially for biology data such as gene expression data and genotype data, that the amount of variables far exceeds the number of samples. The “curse of dimensionality” problem not only affects the computational efficiency of the learning algorithms, but also leads to poor performance of these algorithms. To address this problem, various feature selection methods can be utilized where a subset of important features is selected and the learning algorithms are trained on these features.

### BRIEF SUMMARY

In one embodiment, a computer implemented method for selecting features from a feature space is disclosed. The method includes selecting, by a processor, a candidate feature set of k′ features from at least one set of features based on maximum relevancy and minimum redundancy (MRMR) criteria. A target feature set of k features is identified from the candidate feature, where k′>k. Each a plurality of features in the target feature set is iteratively updated with each of a plurality of k′−k features from the candidate feature set. The feature, for at least one iterative update, from the plurality of k′−k features is maintained in the target feature set based on a current MRMR score of the target feature set satisfying a threshold. The target feature set is stored as a top-k feature set of the at least one set of features after a given number of iterative updates.

In another embodiment, an information processing system for selecting features from a feature space is disclosed. The information processing system includes a memory and a processor that is communicatively coupled to the memory. A feature selection module is communicatively coupled to the memory and the processor. The feature selection module is configured to perform a method. The method includes selecting, by a processor, a candidate feature set of k′ features from at least one set of features based on maximum relevancy and minimum redundancy (MRMR) criteria. A target feature set of k features is identified from the candidate feature, where k′>k. Each a plurality of features in the target feature set is iteratively updated with each of a plurality of k′−k features from the candidate feature set. The feature, for at least one iterative update, from the plurality of k′−k features is maintained in the target feature set based on a current MRMR score of the target feature set satisfying a threshold. The target feature set is stored as a top-k feature set of the at least one set of features after a given number of iterative updates.

In a further embodiment, a computer program product for selecting features from a feature space is disclosed. The computer program product includes a storage medium readable by a processing circuit and storing instructions for execution by the processing circuit for performing a method. The method includes selecting, by a processor, a candidate feature set of k′ features from at least one set of features based on maximum relevancy and minimum redundancy (MRMR) criteria. A target feature set of k features is identified from the candidate feature, where k′>k. Each a plurality of features in the target feature set is iteratively updated with each of a plurality of k′−k features from the candidate feature set. The feature, for at least one iterative update, from the plurality of k′−k features is maintained in the target feature set based on a current MRMR score of the target feature set satisfying a threshold. The target feature set is stored as a top-k feature set of the at least one set of features after a given number of iterative updates.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention; and

FIG. 2 is an operational flow diagram illustrating one example of selecting features from a feature space based on a hill-climbing feature selection mechanism with Max-Relevancy and Minimum-Redundancy criteria according to one embodiment of the present invention.

### DETAILED DESCRIPTION

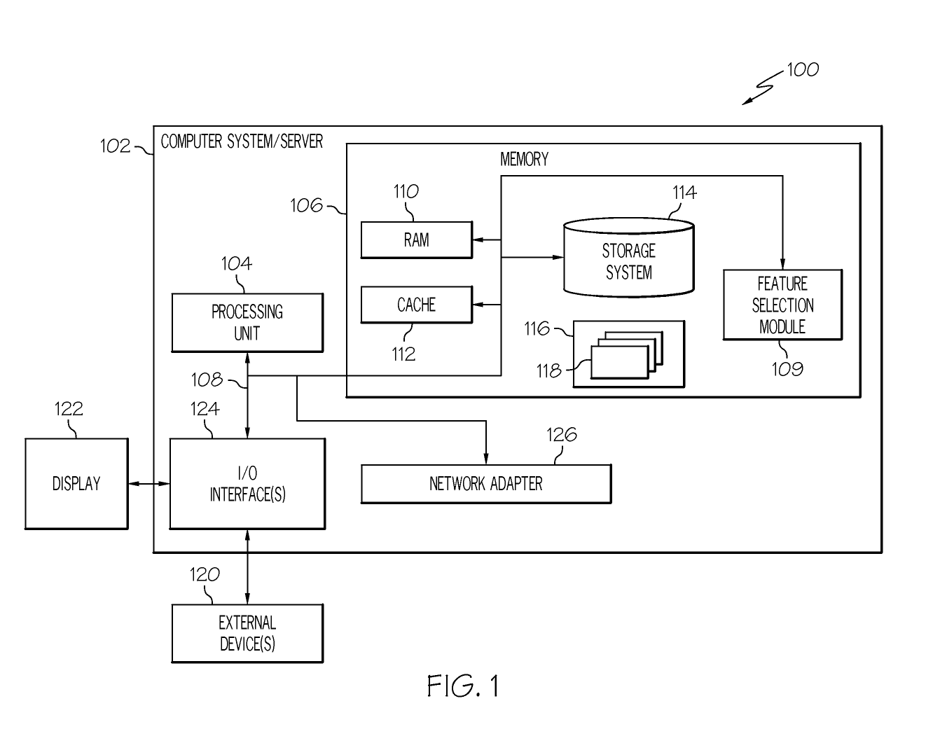

FIG. 1 illustrates a general overview of one operating environment 100 according to one embodiment of the present invention. In particular, FIG. 1 illustrates an information processing system 102 that can be utilized in embodiments of the present invention. The information processing system 102 shown in FIG. 1 is only one example of a suitable system and is not intended to limit the scope of use or functionality of embodiments of the present invention described above. The information processing system 102 of FIG. 1 is capable of implementing and/or performing any of the functionality set forth above. Any suitably configured processing system can be used as the information processing system 102 in embodiments of the present invention.

As illustrated in FIG. 1, the information processing system 102 is in the form of a general-purpose computing device. The components of the information processing system 102 can include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 106, in one embodiment, includes a feature selection module 109 configured to perform one or more embodiments discussed below. For example, in one embodiment, the feature selection module 109 is configured to select a set of features from a feature space using a Max-Relevance and Min-Redundancy (MRMR) selection process. This set of features is then refined and optimized using a hill-climbing MRMR (HMRMR) feature selection process, which is discussed in greater detail below. It should be noted that even though FIG. 1 shows the feature selection module 109 residing in the main memory, the feature selection module 109 can reside within the processor 104, be a separate hardware component capable of e, and/or be distributed across a plurality of information processing systems and/or processors.

The system memory 106 can also include computer system readable media in the form of volatile memory, such as random access memory (RAM) 110 and/or cache memory 112. The information processing system 102 can further include other removable/non-removable, volatile/non-volatile computer system storage media. By way of example only, a storage system 114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. The memory 106 can include at least one program product having a set of program modules that are configured to carry out the functions of an embodiment of the present invention.

Program/utility 116, having a set of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the present invention.

The information processing system 102 can also communicate with one or more external devices 120 such as a keyboard, a pointing device, a display 122, etc.; one or more devices that enable a user to interact with the information processing system 102; and/or any devices (e.g., network card, modem, etc.) that enable computer system/server 102 to communicate with one or more other computing devices. Such communication can occur via I/O interfaces 124. Still yet, the information processing system 102 can communicate with one or more networks such as a local area network (LAN), a general wide area network (WAN), and/or a public network (e.g., the Internet) via network adapter 126. As depicted, the network adapter 126 communicates with the other components of information processing system 102 via the bus 108. Other hardware and/or software components can also be used in conjunction with the information processing system 102. Examples include, but are not limited to: microcode, device drivers, redundant processing units, external disk drive arrays, RAID systems, tape drives, and data archival storage systems.

One criterion for feature selection is referred to as Maximum-Relevance and Minimum-Redundancy (MRMR). In MRMR the selected features should be maximally relevant to the class value, and also minimally dependent on each other. In MRMR, the Maximum-Relevance criterion searches for features that maximize the mean value of all mutual information values between individual features and a class variable. However, feature selection based only on Maximum-Relevance tends to select features that have high redundancy, namely the correlation of the selected features tends to be high. If some of these highly correlated features are removed the respective class-discriminative power would not change, or would only change by an insignificant amount. Therefore, the Minimum-Redundancy criterion is utilized to select mutually exclusive features. A more detailed discussion on MRMR is given in Peng et al., “Feature selection based on mutual information criteria of max-dependency, max-relevance, and min-redundancy”, Pattern Analysis and Machine Intelligence, IEEE Transactions on, 27(8): 1226-1238, 2005, which is hereby incorporated by reference in its entirety.

Conventional feature selection mechanisms based on MRMR generally utilize an incremental search to effectively find the near-optimal features. Features are selected in a greedy manner to maximize an objective function defined based on Maximum-Relevance and Minimum-Redundancy. However, in many instances the order of the features selected by conventional MRMR mechanism are problematic since once a feature is selected it cannot not be removed. Also, some redundant features indeed contain important information.

Therefore, one or more embodiments provide a hill-climbing-based MRMR (HMRMR) feature selection mechanism that searches for a set of features that optimizes the MRMR objective function. As will be discussed in greater detail below, the feature selection module 109 first utilizes MRMR to select a candidate feature set of k′ features from an input set of features. The feature selection module 109 rearranges the order of the features in the candidate feature set of k′ features such that the first k features lead to the best score for the objective function. HMRMR is then performed on a target feature set of k features, where k′>k to identify an optimal set of top-k features.

In one embodiment, the feature selection module 109 receives as input a set of training samples, each including a set of features such as (but not limited to) genetic markers and a class/target value such as (but not limited to) a phenotype. The feature selection module 109 also receives a set of test samples, each including only the same set of features as the training samples, but with target values missing. In one embodiment, features can be represented as rows and samples as columns. Therefore, the training and test datasets comprise the same columns (features), but different rows (samples). The number of features to be selected is also received as input by the feature selection module 109.

It should be noted that in other embodiments the test samples are not received, and the HMRMR selection process is only performed on the training samples. The output of the HMRMR feature selection process performed by the feature selection module 109 is a subset of the input features. If test samples are also provided as input to the feature selection module 109, the selected set of features can be further processed to build a model to predict the missing target values of the test samples.

In one embodiment, the feature selection module 109 maintains two pools of features, one pool for selected features (referred to herein as the “SF pool”), and one pool for the remaining unselected features (referred to herein as the “UF pool”). The UF pool initially includes all the features from the training samples, while the SF pool is initially empty. In this embodiment, features are incrementally selected from a feature set S in a greedy way according to the following:

$${max}_{{x}_{j} ∈ X - {S}_{m - 1}} [ \begin{matrix}I ( {x}_{j}^{training} ; {c}^{training} ) - \\ \frac{1}{m - 1} {\sum }_{{x}_{i} ∈ {S}_{m - 1}} I ( {x}_{j}^{training + test} ; {x}_{i}^{training + test} )\end{matrix} ] , \qquad ( EQ 1 )$$

which simultaneously optimizes the following Maximum-Relevancy and Minimum-Redundancy conditions:

$$\begin{matrix}\begin{matrix}max D ( S , c ) , & D = \frac{1}{\vert S \vert} {\sum }_{{x}_{i ∈ S}} I ( {x}_{i}^{training} ; {c}^{training} ) ,\end{matrix} & ( EQ 2 ) \\ \begin{matrix}min R ( S ) , & R = \frac{1}{{\vert S \vert}^{2}} {\sum }_{{x}_{i} , {x}_{j ∈ S}} I ( {x}_{i}^{training + test} ; {x}_{j}^{trainin + test} ) ,\end{matrix} & ( EQ 3 )\end{matrix}$$

where xⱼ is the jth feature that is sample independent, xⱼ^{training} is the jth feature from a considering a training sample, xⱼ^{training+test} is the jth feature from considering the training and test samples, i is an integer, X is the set of all original input features, Sₘ₋₁ is a set of m−1 features, c is the class value associated with the training data set, and I is mutual information.

Based on the above, each feature xⱼ selected has the largest mutual information I(xⱼ;c) among the current set unselected features with the target class c while considering only the training samples, and has the minimal/least redundancy among the current set of unselected features with respect to the currently selected features in the SF pool while considering both training and test samples, i.e., the sum of the mutual information I between xₘ and all previously selected features xᵢ(i=1, . . . , m−1) is minimized. Mutual information I of two variables x and y can be defined, based on their joint marginal probabilities p(x) and p(y) and probabilistic distribution p(x, y), as:

$$I ( x , y ) = {\sum }_{i , j} p ( {x}_{i} , {y}_{i} ) log \frac{p ( {x}_{i} , {y}_{i} )}{p ( {x}_{i} ) p ( {y}_{i} )} . \qquad ( EQ 4 )$$

It should be noted that other methods for determining the mutual information I of variables can also be used.

The feature selection module 109 continues selecting features until k′ features have been selected. The feature selection module 109 then performs an HMRMR process on a target feature set of k features from this candidate feature set of k′ features to identify an optimal set of top-k features, where k′>k. In particular, as each feature for the candidate feature set of k′ features is selected according to EQ 1 the feature selection module 109 records the order in which each feature is selected. The feature selection module 109 ranks each of the selected features according their selection order. A target feature set of k features is identified from the ranked candidate feature set of k′ features, where k′>k, and calculates the MRMR score of this target feature set. The MRMR score is the sum of the relevance of the entire target feature set minus the sum of the redundancy between every pair of features in the target feature set, as shown in EQ 1.

The feature selection module 109 applies a hill-climbing strategy to the target feature set to identify a set of optimal top-k features. For example, the feature selection module 109 iteratively replaces each feature in the target feature set with each the k′−k features in the ranked candidate feature set resulting in a new/updated target feature set. The feature selection module 109, for each iteration, calculates the MRMR score of the new/updated target feature set based on EQ 1. This MRMR score is compared to a threshold such as the MRMR score calculated for the previous target feature set. If the MRMR score of the new target feature satisfies the threshold, e.g., is an improvement (higher) over the previous MRMR score, the feature selection module 109 keeps the updated in the target feature set. This process is continued for a given number of iterations or until the MRMR score of the target feature set can no longer be improved. It should be noted that because each feature in the target feature set is replaced with each feature in the k′−k features of the ranked candidate feature set and the replacement process is not stopped, even though a replaced feature is kept in the target feature set, the local optimal problem for hill-climbing is avoided.

As an illustrative example assume that the feature selection module 109 initially selects a candidate feature set comprising 2k features, e.g., 200 features where k=100. The feature selection module 109 ranks each of these 200 candidate features based on the order in which they were selected. The feature selection module 109 designates features 1-100 (i.e., k) from the ranked candidate feature set as the target feature set, and calculates an initial MRMR score for this target feature set. The feature selection module 109 iteratively replaces/updates each of the features 1-100 with each of the features 101-200 (i.e., k+1 to 2k features). For example, the feature selection module 109 starts at feature 1 and swaps this feature with feature 101, resulting in a new/updated target feature set.

The feature selection module 109 calculates the new MRMR score for this updated target feature set. If this new MRMR score is an improvement over the previous MRMR score calculated based on the previous state of the target feature set, the updated feature 1 is kept in the target feature set. If this score is not better than the previous MRMR score, the updated feature is reverted back to its previous state (e.g., feature 1 in this example). The above process is continued by iteratively replacing features 2 to 100 each with feature 101, then features 1-100 each with features 102, . . . , 200. This process is continued until the MRMR score can no longer be improved or until a given number of iterations have been performed. The feature selection module 109 outputs the resulting target feature set as the top-k features.

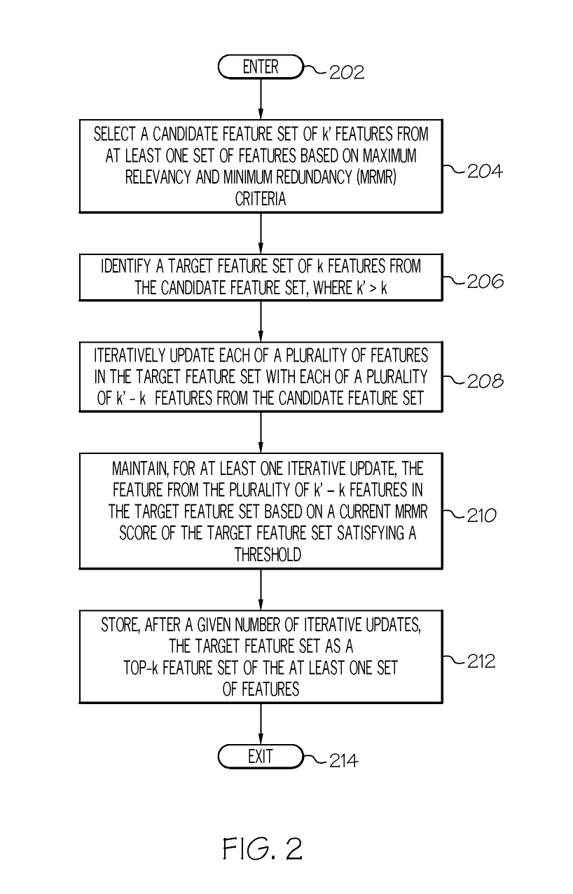

FIG. 2 is an operational flow diagram illustrating one example of an overall process for selecting features from a feature space based on a hill-climbing feature selection mechanism with Max-Relevancy and Minimum-Redundancy criteria. The operational flow diagram begins at step 2 and flows directly to step 204. The feature selection module 109, at step 204, selects a candidate feature set of k′ features from at least one set of features based on maximum relevancy and minimum redundancy (MRMR) criteria. The feature selection module 109, at step 206, identifies a target feature set of k features from the candidate feature, where k′>k.

The feature selection module 109, at step 208, iteratively updates each of a plurality of features in the target feature set with each of a plurality of k′−k features from the candidate feature set. The feature selection module 109, at step 210, maintains the feature from the plurality of k′−k features in the target feature set for at least one iterative update based on a current MRMR score of the target feature set satisfying a threshold. The feature selection module 109, at step 212, stores the target feature set as a top-k feature set of the at least one set of features after a given number of iterative updates. The control flow exits at step 214.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems), and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer implemented method for selecting features from a feature space, the computer implemented method comprising:
selecting, by a processor, a candidate feature set of k′ features from at least one set of features based on maximum relevancy and minimum redundancy (MRMR) criteria;
identifying a target feature set of k features from the candidate feature set, where k′>k;
iteratively updating each of a plurality of features in the target feature set with each of a plurality of k′−k features from the candidate feature set;
maintaining, for at least one iterative update, the feature from the plurality of k′−k features in the target feature set based on a current MRMR score of the target feature set satisfying a threshold; and
storing, after a given number of iterative updates, the target feature set as a top-k feature set of the at least one set of features.

2. The computer implemented method of claim 1, wherein determining the candidate feature set of k′ features comprises:
determining, for each of the at least one set of features, a relevancy with respect to a class value;
determining, for each of the at least one set of features, a redundancy with respect to the one or more of the at least one set of features; and
selecting each the candidate feature set from the at least one set of features based on the relevancy and the redundancy determined for each of the at least one set of features.

3. The computer implemented method of claim 1, further comprising:
ranking each of the set of candidate features based on an order in which each of the set of candidate features were selected from the at least one set of features,
wherein the k features are a set of k highest ranking features in the set of candidate features.

4. The computer implemented method of claim 1, wherein the current MRMR score of the target set of features for each iterative update comprises:
determining a relevance of each of the set of target features with respect to a class value associated with the at least one set of features;
determining a redundancy between each pair of features in the target set of features; and
determining the MRMR score based on a sum each determined relevances minus a sum of each of the determined redundancies.

5. The computer implemented method of claim 1, wherein maintaining the feature from the plurality of k′−k features in the target feature set comprises:
comparing the current MRMR score to a previous MRMR score of the target feature set; and
maintaining the feature from the plurality of k′−k features in the target feature set based on the current MRMR score being an improvement over the previous MRMR score.

6. The computer implemented method of claim 1, further comprising:
removing, for at least one iterative update, the feature in the plurality of k′−k features from the target feature set based on a current MRMR score for the target feature failing to satisfy a threshold.

7. The computer implemented method of claim 6, wherein removing the feature in the plurality of k′−k features from the target feature set comprises:
comparing the current MRMR score to a previous MRMR score of the target feature set; and
removing the feature in the plurality of k′−k features from the target feature set based on the current MRMR score failing to be an improvement over the previous MRMR score.

8-20. (canceled)
